(19) United States
(12) Patent Application Publication
(10) Pub. No.: US 2022/0056681 A1
(43) Pub. Date: Feb. 24, 2022

(54) MOBILE HANDWASHING SYSTEM

(71) Applicant: ILLINOIS TOOL WORKS INC., Glenview, IL (US)

(72) Inventors: Dennis FIRCHAU, Baden-Baden (DE); Marco JUNKER, Offenburg (DE)

(21) Appl. No.: 17/404,103

(22) Filed: Aug. 17, 2021

(30) Foreign Application Priority Data
Aug. 20, 2020 (DE) 10 2020 121 848.6

(51) Int. Cl. E03C 1/182; E03B 1/04; E03F 5/10

(52) U.S. Cl. CPC E03C 1/182; E03F 5/10; E03B 1/04

(57) ABSTRACT

A mobile handwashing system (1) includes a freestanding supply station (2) and at least one freestanding handwashing station (3). The supply station (2) includes a freshwater tank (4), which is fluidly connected or connectable to the at least one handwashing station (3) via a first freshwater supply line (5) and is fluidly connected or connectable to a freshwater supply system via a second freshwater supply line (6). The supply station (2) includes a wastewater or graywater tank (7) and/or a wastewater pump (23) which is fluidly connected or connectable to the at least one handwashing station (3) via a first wastewater line (8) and is fluidly connected or connectable to a wastewater disposal or wastewater treatment system via a second wastewater line (9).

### TECHNICAL FIELD

The present invention relates generally to mobile cleaning stations that are particularly suitable for handwashing. Specifically, the invention relates to a mobile handwashing system comprising at least one freestanding handwashing station and, in particular, a flexibly selectable number of freestanding handwashing stations.

### BACKGROUND

The European Union (EU) is committed to respecting the health protection of its citizens in all areas and, together with EU countries, improving public health, preventing illness, and limiting sources of risk to both physical and mental health. The EU Health Program sets out the strategy for ensuring good health and medical care.

The legal basis for the EU Health Program in progress on the filing date of the present invention is Regulation (EU) No. 282/2014. The program is specifically aimed at protecting citizens against serious cross-border health risks.

In particular, an implementation of this so-called Third Program “Health” (2014-2020) is currently not viable, or at least not with [sic: without] increased effort, in the cruise industry.

A “cruise” as defined in the present application is a vacation on a cruise ship, wherein this vacation occurs along a fixed route between various tourist destinations and ports. In particular, these are the different tourist destinations and ports that make a vacation on a cruise ship attractive to vacationers.

Such cruises were popular with travelers until the COVID-19 pandemic broke out at the beginning of 2020. However, in March 2020, tour operators around the world cancelled their cruises, because it was not possible to ensure that travelers are properly protected against serious cross-border health hazards due to the wide large number of stopovers at the various tourist destinations and ports. This is also in particular due to the fact that there often do not exist optimal hygienic and health conditions at the tourist destinations and ports visited by the cruise ships.

The European Union (EU) working group on “Healthy Gateways” published preliminary recommendations for resuming cruising operations on Jun. 30, 2020. In response, the Cruise Lines International Organization presented its “Guiding Principles for Resuming Cruise Operations,” which focus on a detailed hygiene concept, staff training, and measures for handling people on board who are infected or suspected of having an infection.

In this context, the detailed hygiene concept in particular provides for passengers to at least wash their hands sufficiently after a landing and before reboarding the cruise ship, because, as is known, hands are the most common carriers of pathogens. In this way, transmission of pathogens as a result of a smear infection is to be prevented.

However, with the currently available and known approaches, it is not possible, or at least not possible without extremely complex measures, to enable passengers to wash their hands with a sufficient degree of hygiene after a landing and before reboarding the cruise ship.

A mobile cleaning station that is particularly suitable for washing hands is indeed known from the publication DE 20 2020 101 660 U1. However, such a mobile cleaning station is not really usable in practice, in particular in the cruise line business, because, due to the limited docking time of the cruise ship at the respective tourist destinations and ports, the assembly and disassembly of a variety of such mobile cleaning stations, for example on the pier of the cruise ship, is not feasible in practice.

### SUMMARY

Based on this situation, the problem of the invention is based on the goal of providing a novel handwashing system, in particular a mobile handwashing system, which can be assembled and disassembled in a short time and which functions, in particular, autonomously from a local freshwater network and a local wastewater network, wherein simultaneously the transmission of pathogens is effectively prevented, in particular as the result of a smear infection.

In order to solve this problem, a mobile handwashing system according to the invention is given according to independent claim 1, wherein advantageous further developments of the mobile handwashing system according to the invention are given in the corresponding dependent claims.

According to these claims, the invention relates in particular to a mobile handwashing system comprising a freestanding supply station and at least one freestanding handwashing station. The freestanding supply station as well as the at least one freestanding handwashing station are configured in order to be assembled externally to the cruise ship, for example at the pier of the cruise ship.

According to the invention, the supply station comprises a freshwater tank that is fluidly connected or connectable to the at least one handwashing station via a first freshwater supply line and is fluidly connected or connectable to a freshwater supply system via a second freshwater supply line.

The freshwater supply system described here is, in particular, arranged separately from a public freshwater network. For example, the freshwater system is an on-board drinking water supply system of a ship, particularly a cruise ship.

According to the invention, the supply station of the mobile handwashing system according to the invention further comprises a wastewater or graywater tank and/or a wastewater pump that is fluidly connected or connectable to the at least one (freestanding) handwashing station via a first wastewater line and is fluidly connected or connectable to a wastewater disposal or wastewater treatment system via a second wastewater line.

The wastewater disposal or wastewater treatment system is, in particular, separate from the public wastewater system, wherein the wastewater disposal or wastewater treatment system is, in particular, an on-board wastewater disposal or wastewater treatment system of a ship, in particular a cruise liner.

The advantages achievable with the mobile handwashing system according to the invention are clear: by using a freestanding supply station and at least one freestanding handwashing station in the mobile handwashing system according to the invention, as opposed, for example, to the mobile handwashing station known from publication DE 20 2020 101 660 U1, it is possible to execute the freestanding handwashing stations without a freshwater tank and a wastewater or a graywater tank. This provides the decisive advantage that the freestanding handwashing stations can be executed particularly compactly, so that these freestanding handwashing stations can in particular be designed as easy-to-handle, mobile units.

In this context, it is preferably conceivable for the freestanding handwashing stations to be equipped with, for example, rollers or wheels, in particular heavy-duty rollers or heavy-duty wheels, so that they can be transported manually and preferably only by a single person to the place of set-up, for example on the pier of the cruise ship, and transported away accordingly.

In particular, the solution according to the invention provides that all structural components necessary for the freshwater supply and wastewater disposal of the freestanding handwashing stations are not integrated in the handwashing station itself, but rather in the freestanding supply station. This relates in particular to the freshwater tank provided in the supply station, which serves to supply freshwater to the freestanding handwashing stations.

In this context, it is important to note the wastewater or graywater tank, which is provided in the supply station itself (and not in the corresponding freestanding handwashing stations) and which serves to store the wastewater/graywater that is accrued during the use of the freestanding handwashing stations.

However, the solution according to the invention is in particular also characterized in that the supply station does not necessarily have to be connected to a local freshwater or wastewater network. Rather, the supply station of the mobile handwashing system according to the invention is fluidly connected or connectable to a freshwater supply system via a corresponding freshwater supply line (second freshwater supply line), wherein, in particular, it is not a local freshwater network but rather, in particular, an on-board freshwater supply system.

The same applies to the wastewater disposal: in the mobile handwashing system according to the invention, it is provided that the freestanding supply station is fluidly connected or connectable to a wastewater disposal or wastewater treatment system via a corresponding wastewater line (second wastewater line), wherein this wastewater disposal or wastewater treatment system does not have to be a local wastewater network, in particular; rather, this wastewater disposal or wastewater treatment system is, in particular, an on-board wastewater disposal or wastewater treatment system.

In other words, the mobile handwashing system is—with respect to the local infrastructure—fully self-contained. At the same time, the individual components of the mobile handwashing system are designed compactly and optimally in terms of weight, such that they can be set up and taken down as mobile units without major effort, and in particular also manually, on site, i.e. on the pier of the cruise ship, for example. In this way, the mobile handwashing system can be assembled and disassembled without increased personnel effort and without taking up an excessive length of time.

Preferably, at least two freestanding handwashing stations are provided in the mobile handwashing system according to the invention. In particular, a flexibly selectable number of such handwashing stations are provided.

These at least two handwashing stations are fluidly connected in series, such that a first one of the at least two handwashing stations is directly connected or connectable to the freshwater tank of the supply station via the first freshwater supply line and a second one of the at least two handwashing stations is fluidly connected or connectable to the first one of the at least two handwashing stations via a third freshwater supply line and from there to the freshwater tank of the supply station via the first freshwater supply line.

By way of such a serial connection in the hydraulic sense, a plurality of freestanding handwashing stations to be connected to the (freestanding) supply station without incurring excessive effort in the fluid connection of the individual handwashing stations.

According to further developments of the latter aspect, it is provided in particular that each handwashing station comprises a first line connection for the first or a third freshwater supply line and a second line connection (located separately from the first line connection) for a third freshwater supply line. The provision of two line connections for such freshwater supply lines is a particularly feasible but nevertheless effective manner in which to implement a fluid serial circuit of the individual handwashing stations.

In this context, it is provided in particular that a seal in the form of a backflow blocker is preferably assigned to each line connection for preferably self-actuated closing (e.g. with the aid of a check valve) or for manual closing (e.g. with the aid of a ball valve) of the corresponding line connection when no freshwater supply line is connected to the line connection in question.

According to preferred implementations or further developments of the latter aspect, it is provided that the first line connection is fluidly connected to the second line connection via a first freshwater connection line that is preferably integrated in the handwashing station. On the other hand, it is provided that the first freshwater connection line is fluidly connected to a particularly sensor-controlled faucet of the handwashing station via a second freshwater connection line that is preferably integrated in the handwashing station.

Of course, however, other embodiments may also be considered for the formation of a fluid serial connection of the handwashing stations.

According to conceivable embodiments, it is provided that the at least one handwashing station comprises a bypass line for fluidly connecting the first freshwater connection line to the first wastewater connection line, as needed. With the aid of such a bypass line, it can be achieved that only suitably heated freshwater for handwashing is supplied at all times to the handwashing station. If, for example, the freshwater temporarily stored in the freshwater tank of the supply station becomes too hot due to extreme solar irradiation, the bypass line is preferably automatically released so that the freshwater that is not suitably heated is not supplied to the handwashing station faucet, but is rather directly supplied to the wastewater connection line.

Alternatively, however, it is also conceivable that a bypass is provided from the first freshwater supply line to the wastewater line, as needed, for example by manual connection of the second freshwater line connection and the second wastewater line connection. Preferably, the bypass can only be manually attached to the last handwashing station. In particular, the bypass should have an integrated backflow blocker (“water-break”) in order to separate freshwater and wastewater flows.

According to a further aspect of the present invention, the mobile handwashing system according to the invention comprises at least two freestanding handwashing stations and preferably a flexibly selectable number of (a plurality of) handwashing stations. The at least two handwashing stations are fluidly connected in series such that a first one of the at least two handwashing stations is fluidly connected or connectable directly to the wastewater or graywater tank of the supply station via the first wastewater line and a second one of the at least two handwashing stations is fluidly connected or connectable via a third wastewater line to the first of the at least two handwashing stations and from there to the wastewater or graywater tank of the supply station via the first wastewater line.

This is a particularly efficient yet easily feasible solution for the fluid serial connection of the handwashing stations in question. Of course, it goes without saying that the invention is not limited to this solution.

According to a further development of the latter aspect, it is provided that each handwashing station comprises a first line connection for the first or a third wastewater line and a second line connection for a third wastewater line. In this context, it is preferably provided that a seal, in particular in the form of a backflow blocker, is assigned to each line connection for preferably self-actuated closing (e.g. with the aid of a check valve) or for manual closing (e.g. with the aid of a ball valve) of the corresponding line connection when no wastewater supply line is connected to the line connection in question.

Of course, however, other embodiments are conceivable for the realization of a corresponding fluid serial connection of the individual handwashing stations.

According to a preferred further development of the handwashing system according to the invention, and in particular the latter aspect of the handwashing system according to the invention, it is provided that the first line connection is fluidly connected to the second line connection via a first wastewater connection line that is preferably integrated in the handwashing station. In particular, the first wastewater connection line should be fluidly connected to a sink of the handwashing station via a second wastewater line that is preferably integrated in the handwashing station.

Again, the aforementioned applies here: other embodiments are of course also conceivable for a fluid serial connection of the individual handwashing stations of the handwashing system according to the invention.

In this context, it is appropriate for the at least one handwashing station to comprise a bypass for the fluid connection of the second line connection for the third freshwater supply line to the second line connection for the third wastewater line, as needed. Preferably, the bypass can only be manually attached to the last handwashing station. In particular, the bypass should have an integrated backflow blocker (“water-break”) in order to separate freshwater and wastewater flows.

According to embodiments of the mobile handwashing system, it is provided that the supply station comprises a freshwater pump for establishing and maintaining a default or adjustable water pressure in the freshwater tank of the (freestanding) supply station.

Alternatively or additionally hereto, the supply station may comprise a freshwater pump for establishing and/or maintaining a default or adjustable water pressure in the first freshwater supply line.

Alternatively or additionally hereto, according to further developments of the mobile handwashing system according to the invention, it is provided that the supply station comprises a wastewater pump that is fluidly connected or connectable on the suction side to the first wastewater line and is fluidly connected or connectable on the pressure side to the second wastewater line.

Alternatively or additionally hereto, the supply station may comprise a wastewater pump which is fluidly connected or connectable on the suction side to the wastewater tank or graywater tank and is fluidly connected or connectable on the pressure side to the second wastewater line.

In this way, it is possible to integrate all of the components relating to the freshwater supply and wastewater disposal in the freestanding supply station and, in particular, not to provide them in the freestanding handwashing stations. Of course, alternative and other embodiments can also be considered here, as well.

According to an aspect of the present invention, the freshwater tank of the supply station is arranged at least in regions above the wastewater or graywater tank of the supply station. Further, a bypass line with a valve, which can be operated preferably manually or controlled via a control device, is also provided in order to form a fluid connection between the freshwater tank and the wastewater or graywater tank of the supply station, as needed. This is required, for example, when the mobile handwashing system is to be disassembled and the freshwater tank of the supply station is to be emptied accordingly. The wastewater or graywater tank of the supply station is emptied by activating the wastewater pump of the supply station.

With regard to the supply station of the mobile handwashing system according to the invention, it is advantageous that a level sensor is assigned to the freshwater tank of the supply station, said level sensor being signally connected to a control device of the supply station, wherein the control device is configured in order to establish a fluid connection of the freshwater tank to the freshwater supply system via the second freshwater supply line upon reaching or falling below a default or adjustable liquid level in the freshwater tank sensed by means of the level sensor.

Alternatively or additionally hereto, it is appropriate for a corresponding level sensor to be assigned to the wastewater or graywater tank of the supply station, said level sensor being signally connected to a control device of the supply station. The control device should, in particular, be configured in order to establish a fluid connection of the wastewater or graywater tank to the wastewater disposal or wastewater treatment system via the second wastewater line upon reaching or exceeding a default or adjustable liquid level in the wastewater or graywater tank sensed by means of the level sensor.

As stated above, the freshwater supply system is, in particular, separate from the public freshwater network. For example, the freshwater system is an on-board drinking water supply system of a ship, particularly a cruise ship.

Likewise, it is preferably provided that the wastewater disposal or wastewater treatment system is separate from the local (public) wastewater network. For example, the wastewater disposal or wastewater treatment system is an on-board wastewater disposal or wastewater treatment system of a ship, in particular a cruise ship.

Preferably, the at least one handwashing station comprises a power supply that is autonomous from the supply station in order to supply power to the electrical consumers of the handwashing station, wherein the self-contained power supply comprises in particular an accumulator and a water-flow generator and/or a photovoltaic cell.

According to a further aspect of the present invention, it is provided that a temperature sensor is assigned to the wastewater or graywater tank of the supply station and/or the freshwater tank of the supply station for monitoring the temperature of the wastewater supplied by the at least one handwashing station to the wastewater or graywater tank or for monitoring the temperature of the freshwater supplied by the freshwater tank of the at least one handwashing station.

The at least one temperature sensor is preferably signally connected to a control device of the supply station, wherein the control device is configured, in particular, to interrupt or prevent a supply of freshwater to the at least one handwashing station when the temperature of the freshwater in the freshwater tank and/or the temperature of the wastewater in the wastewater or graywater tank sensed by the temperature sensor reaches or exceeds a default or adjustable value of approximately 40° C., in particular.

Finally, according to further developments of the mobile handwashing system according to the invention, it is provided that a tempering device (heating and/or cooling device) is assigned to the freshwater tank of the supply station in order to properly temper the liquid (freshwater) received in the freshwater tank to a default or adjustable temperature value or temperature range.

### BRIEF DESCRIPTION OF THE DRAWINGS

Exemplary embodiments of the invention are described in greater detail below with reference to the accompanying drawings.

The figures show:

FIG. 1 schematically, an exemplary embodiment of the mobile handwashing system according to the invention when in use on the pier of a cruise ship;

FIG. 2 schematically, a hydraulic diagram of an exemplary embodiment of the mobile handwashing system according to the invention when in use in a cruise ship;

FIG. 3 schematically and in an isometric view, an exemplary embodiment of the supply station of the handwashing system according to the invention;

FIG. 4 schematically, the components used in the exemplary embodiment of the supply station according to FIG. 3;

FIG. 5 schematically and in an isometric view, an exemplary embodiment of a handwashing station of the handwashing system according to the invention;

FIG. 6 schematically and in a side view, the handwashing station according to FIG. 5 in a partially-cut view; and

FIG. 7 schematically, the handwashing station according to FIG. 5 in a front view.

### DETAILED DESCRIPTION

Although an exemplary embodiment of the mobile handwashing system 1 according to the invention is described below partly in connection with a cruise ship 27, the invention is in no way limited to this scope.

In particular, the mobile handwashing system 1 according to the invention is not only suitable for providing a handwashing station 3 outside a ship, in particular a cruise ship 27. Rather, of course, the mobile handwashing system 1 according to the invention can also be used on board, for example in front of a restaurant or casino area of a ship, in particular a cruise ship 27.

The mobile handwashing system 1 according to the invention is also suitable for totally different applications, for example for concerts or other events or for conferences within a building complex. Of course, the above list is not to be considered to be exhaustive.

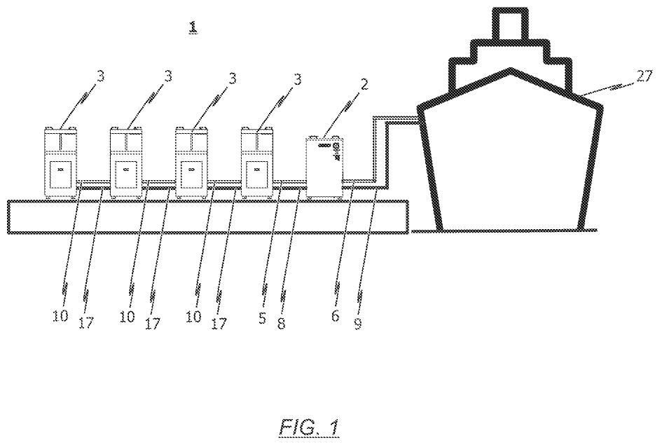

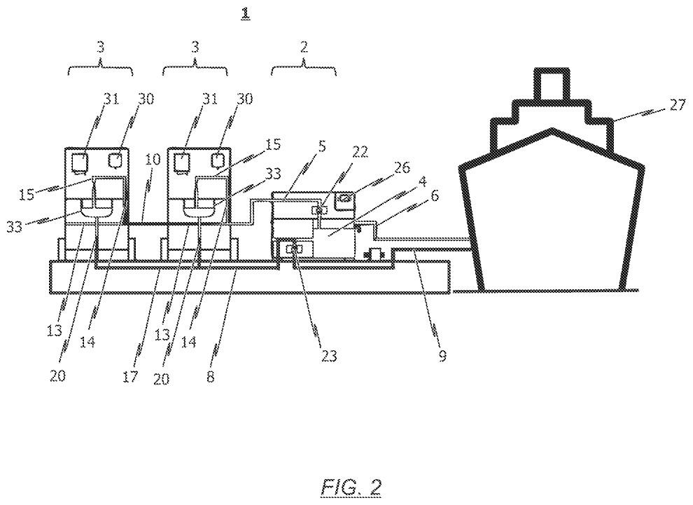

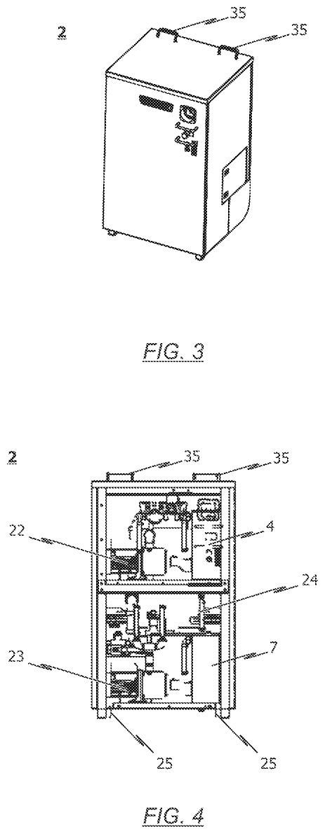

Briefly summarized, the mobile handwashing system 1 according to the invention comprises a supply station 2 and a flexibly selectable number of handwashing stations 3, which can be connected in series and serviced with freshwater and wastewater from the supply station 2 (see, for example, FIG. 1 and FIG. 2).

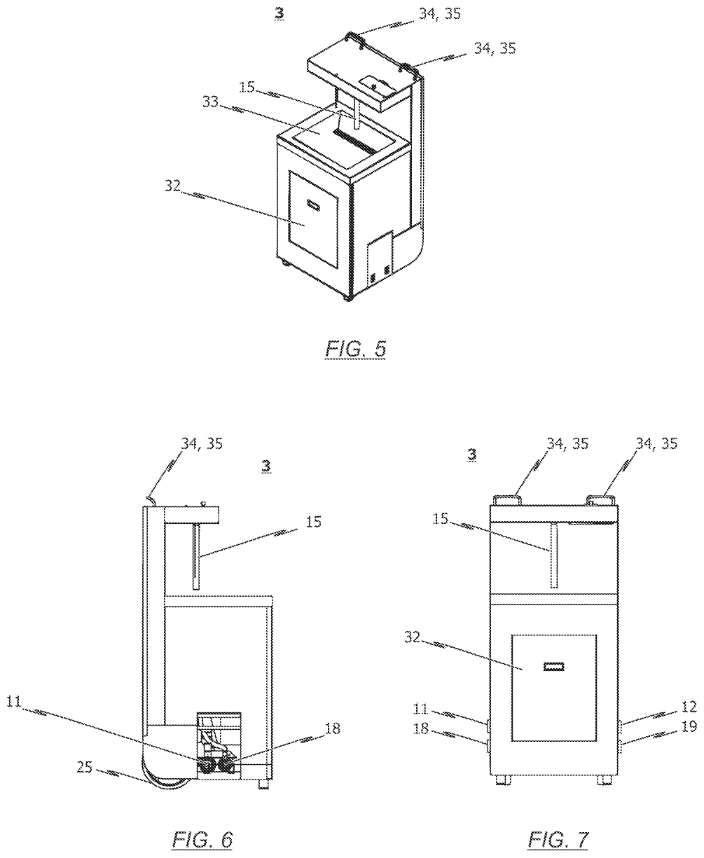

The individual handwashing stations 3 (see, for example, FIG. 5 to FIG. 7) are preferably made of stainless steel and have an exterior design that is appealing and easy to clean, in particular. Each handwashing station 3 preferably contains an integrated and sensor-controlled faucet 15 and soap foam dispenser 30 in order to allow for touchless handwashing. A paper towel dispenser 31 and an easily removable trash can 32 are also preferably integrated.

There is preferably a large trash receptacle at the front of the handwashing station 3. Lateral splash protection and wind protection walls are integrated in order to protect the water jet and soap against wind when set up outdoors. The drain of the sink 33 is protected with a grid in order to prevent clogs.

By means of an integrated laser (protection class 1), the positions for the leakage of soap and water are indicated. As soon as soap or water is activated, an LED lights up in order to visually signal the respective operation. As soon as the water is activated, a visual countdown, for example of 20 to 30 seconds, runs in order to support the duration of handwashing. The faucet 15, the soap dispenser 30, the laser, and the LED's are powered by a common battery, which is recharged by a hydrogenerator (water flow generator). The faucet 15 has an integrated continuous rinsing function, which can be manually activated or deactivated at the touch of a button.

The handwashing station 3 has two heavy-duty rollers 25 and corresponding handles 34, which make the unit movable by tilting. Adjustable feet guarantee a firm footing any all times. Furthermore, the handwashing station 3 is equipped with a plurality of heavy-duty hooks 35 in order to be moved with a crane.

Lateral fold-out coat hooks are preferably integrated in order to be able to hang items of clothing, such as jackets, etc., during handwashing. The handwashing station 3 has a labeled storage shelf for handbags, briefcases, and other items.

On the individual handwashing stations 3, the freshwater and the wastewater can be connected bilaterally and forwarded accordingly to a further handwashing station 3.

The supply station 2 is equipped in the upper level with a freshwater tank 4 and a freshwater pump 22. The freshwater tank 4 is connected to an on-site or on-board water connection. The freshwater pump 22 establishes the necessary water pressure for the connected handwashing stations 3.

Further, in the lower level, the supply station 2 has a wastewater tank 7 and a wastewater pump 23, which pumps the collected wastewater in a line back to an on-site or on-board drain. The contents of the freshwater tank 4 can be manually drained into the wastewater tank 7. The fresh and wastewater line connections 8, 9 11, 12 are designed in order to be non-exchangeable.

The supply station 2 has two heavy-duty rollers 25 and corresponding handles 34, which make the unit movable by tilting. Adjustable feet guarantee a firm footing any all times. Furthermore, the supply station 2 is equipped with a plurality of heavy-duty hooks in order to be moved with a crane.

The freshwater and wastewater can be connected bilaterally, both for forwarding to the handwashing station 3 and for on-site or on-board supply.

Temperature monitoring in the wastewater tank 7 ensures that an emergency shutdown is activated at, for example, above 40° C. in order to prevent possible burning/scalding from heated water.

The supply station 2 is scalable according to the number of handwashing stations 3 that are to be connected.

According to embodiments, the PLC control of the supply station 2 has a display and can map the following functions:
power on/off;
emergency off switch;
water flow monitoring;
leakage detector; and/or
visual error output.

A continuous water flow rate can be established by means of a bypass at the last handwashing station 3. This prevents the standing water from heating to over 40° C. when the system is constructed outdoors in high solar irradiation and the sinks are not in use.

The connection lines/connection hoses between the individual stations have a seal so that water does not leak out during disassembly of the system. The connection hoses/connection lines can be drained through a nozzle of the wastewater tank.

After use of the system, a cleaning tablet can be inserted into the freshwater tank 4 in order to clean the system with the cleaning function of the handwashing stations 3.

A specific exemplary embodiment of the handwashing system 1 according to the invention is shown schematically in FIG. 1.

Briefly summarized, the handwashing system 1 comprises a freestanding supply station 2 as well as a flexible number of freestanding handwashing stations 3.

As can be seen in the hydraulic diagram according to FIG. 2, the supply station 2 comprises a freshwater tank 4, which is fluidly connected or connectable to the handwashing stations 3 via a first freshwater supply line 5.

Furthermore, the freshwater tank 4 of the supply station 2 is fluidly connected or connectable to a freshwater supply system via a second freshwater supply line 6. In the exemplary embodiment shown in FIG. 1 and FIG. 2, the freshwater supply system is separate from the public freshwater network and is, in particular, an on-board drinking water supply system of a cruise ship 27.

The hydraulic diagram according to FIG. 2 further shows that the supply station 2 of the handwashing system 1 comprises a wastewater or graywater tank 7 that is fluidly connected or connectable to the handwashing stations 3 via a first wastewater line 8 and is fluidly connected or connectable to a wastewater disposal or wastewater treatment system via a second wastewater line 9.

Like the freshwater supply system, the wastewater disposal or wastewater treatment system is separate from the public wastewater system and is, in particular, an on-board wastewater disposal or wastewater treatment system of a ship.

In the handwashing system 1 according to the invention, the handwashing stations 3 are fluidly connected in series such that a first handwashing station 3 is directly connected or connectable to the freshwater tank 4 of the supply station 2 via the first freshwater supply line 5, wherein a second handwashing station 3 adjacent to the first handwashing station 3 is fluidly connected or connectable to the first handwashing station 3 via a third freshwater supply line 10 and from there to the freshwater tank 4 of the supply station 2 via the first freshwater supply line 5. A third handwashing station 3 adjacent to the second handwashing station 3 is in turn fluidly connected or connectable to the second handwashing station 3 via a third freshwater supply line 10 and from there to the first handwashing station 3 via the aforementioned third freshwater supply line 10 assigned to the second handwashing station 3 and from there to the freshwater tank 4 of the supply station 2 via the first freshwater supply line 5.

Similarly, with respect to the wastewater line, the individual handwashing stations 3 are fluidly connected in series. Specifically, the first handwashing station 3 is fluidly connected or connectable directly to the wastewater or graywater tank 7 of the supply station 2 via the first wastewater line 8, wherein the second handwashing station 3 is fluidly connected or connectable to the first handwashing station 3 via a third wastewater line 17 and from there to the wastewater or graywater tank 7 of the supply station 2 via the first wastewater line 8. The further handwashing stations 3 are also fluidly connected to the adjacent handwashing station 3 via a correspondingly assigned third wastewater line 17 and from there ultimately to the wastewater or graywater tank 7 of the supply station 2.

As can be seen in the illustration in FIG. 6, in particular, each handwashing station 3 comprises a first line connection 11 for the first or a third freshwater supply line 10 and a second line connection 12 for a third freshwater supply line 10. In particular, in the embodiments shown in the drawings, it is provided that the first line connection 11 is configured on a first side of the handwashing station 3 and the second line connection 12 is configured on an opposite second side of the handwashing station 3 in order to be able to implement as simple a serial connection as possible for the individual handwashing stations 3.

It can be seen from the hydraulic diagram according to FIG. 2 that the first line connection 11 is fluidly connected to the second line connection 12 of the corresponding handwashing station 3 via a first freshwater connection line 13, which is preferably integrated in the handwashing station 3. In addition, the first freshwater connection line 13 is fluidly connected to a particularly sensor-controlled faucet 15 of the handwashing station 3 via a second freshwater connection line 14, which is preferably integrated in the handwashing station 3.

Although not shown in the drawings, it is advantageous for the handwashing station 3 to have a bypass line for the fluid connection of the first freshwater connection line 13 to the first wastewater connection line, as needed. This bypass line can be opened as needed when, for example, the temperature of the freshwater temporarily stored in the freshwater tank 4 of the supply station 2 has heated too far, in particular due to intense solar irradiation, so that this freshwater can no longer be used for handwashing, because scalding could otherwise occur.

The activation of the bypass line is preferably carried out automatically by means of a control device of the supply station 2.

It can also be seen in the illustration in FIG. 6 that each handwashing station 3 has a first line connection 18 for the first or a third wastewater line 8, 17 and a second line connection 19 for a third wastewater line 17. Like the line connections 11, 12 for the freshwater supply lines 5, 10, the first line connection 18 for the wastewater line 8, 17 is arranged on a first side of the handwashing station 3, and the second line connection 19 for the wastewater line 17 is arranged on an opposite second side of the handwashing station 3.

In this context, it is fundamentally advantageous that all of the line connections 11, 12, 18, 19 of the handwashing station 3 are equipped with a seal, in particular in the form of a backflow blocker, in order to automatically close the line connection 11, 12, 18, 19 when no line (freshwater supply line or wastewater line) is connected to the nozzle in question.

The hydraulic diagram according to FIG. 2 shows that the first line connection 18 for the wastewater line 8, 17 is fluidly connected to the second line connection 19 for the wastewater line 17 via a first wastewater connection line, which is preferably integrated in the handwashing station 3. The first wastewater connection line is fluidly connected to a sink 33 of the handwashing station 3 via a second wastewater connection line 20, which is preferably integrated at the handwashing station 3.

According to the illustration in FIG. 4, the supply station 2 comprises a freshwater pump 22 for establishing and maintaining a default or adjustable water pressure in the freshwater tank 4 of the supply station 2.

Furthermore, the supply station 2 comprises a wastewater pump 23, which is fluidly connected or connectable on the suction side to the first wastewater line 8 and is fluidly connected or connectable on the pressure side to the second wastewater line 9.

In particular, it is provided in the exemplary embodiment that the freshwater tank 4 of the supply station 2 is arranged at least in regions above the wastewater or graywater tank 7 of the supply station 2. Further, a bypass line 24 with a valve, which can be operated preferably manually or controlled via a control device 26, is provided in order to form a fluid connection between the freshwater tank 4 and the wastewater or graywater tank 7 of the supply station 2, as needed.

According to the invention, it is provided in particular that the supply station 2 and the respective handwashing stations 3 are respectively configured as mobile units and are equipped in particular with heavy-duty rollers or heavy-duty wheels 25. In this manner, the individual units of the handwashing system 1 can be easily assembled and disassembled, in particular manually.

Preferably, a level sensor is assigned to the freshwater tank 4 of the supply station 2, said level sensor being signally connected to a control device 26 of the supply station 2. In particular, the control device 26 is configured in order to establish a fluid connection between the freshwater tank 4 and the freshwater supply system via the second freshwater supply line 6 upon reaching or falling below a default or adjustable liquid level in the freshwater tank 4 sensed by means of the level sensor.

In the same manner, it is appropriate for a level sensor to be assigned to the wastewater or graywater tank 7 of the supply station 2, said level sensor being signally connected to a control device 26 of the supply station 2, wherein the control device 26 is configured, in particular, in order to establish a fluid connection of the wastewater or graywater tank 7 to the wastewater disposal or wastewater treatment system via the second wastewater line 9 upon reaching or exceeding a default or adjustable liquid level in the wastewater or graywater tank 7 sensed by means of the level sensor.

According to further developments of the invention, it is provided that a temperature sensor is assigned to the wastewater or graywater tank 7 of the supply station 2 and/or the freshwater tank 4 of the supply station 2 for monitoring the temperature of the wastewater supplied by the at least one handwashing station 3 to the wastewater or graywater tank 7 or for monitoring the temperature of the freshwater supplied by the freshwater tank 4 to the handwashing stations 3.

Preferably, the at least one temperature sensor is signally connected to a control device 26 of the supply station 2, wherein the control device 26 is configured, in particular, in order to automatically or selectively interrupt or prevent a supply of freshwater to the handwashing stations 3 when the temperature of the freshwater in the freshwater tank 4 and/or the temperature of the wastewater in the wastewater or graywater tank 7 sensed by the temperature sensor reaches or exceeds a default or adjustable value of approximately 40° C., in particular.

Although not shown in the drawings, it is appropriate for a tempering device to be assigned to the freshwater tank 4 of the supply station 2 in order to temper the liquid received in the freshwater tank 4. This tempering device can be a heating element or a cooling element, for example.

With the handwashing system 1 according to the invention, the most important and best method of hand hygiene is expanded in an easy-to-implement yet effective manner, namely in applications where it is currently not yet possible. The handwashing system 1 according to the invention thus contributes to improved hygiene safety.

The advantages achievable with the handwashing system 1 according to the invention can be summarized as follows:
simple mobility in order to allow for set-up anywhere;
ensuring rapid assembly and disassembly;
flexibly adaptable for any number of people (also suitable for large events with several thousand people);
independence of sanitary facilities or supply on-site;
robust design to ensure longevity and sustainability;
contactless handwashing; and
simple storage due to minimized storage surfaces.

The invention is not limited to the specific embodiment shown in the drawings, but rather results from a joint consideration of all of the features disclosed herein.

### LIST OF REFERENCE NUMERALS

1 Mobile handwashing system
2 Supply station
3 Handwashing station
4 Freshwater tank
5 First freshwater supply line
6 Second freshwater supply line
7 Wastewater or graywater tank
8 First wastewater line
9 Second wastewater line
10 Third freshwater supply line
11 First line connection for freshwater supply line
12 Second line connection for freshwater supply line
13 First freshwater connection line
14 Second freshwater connection line
15 Faucet
16 Bypass line of the handwashing station
17 Third wastewater line
18 First line connection for wastewater line
19 Second line connection for wastewater line
20 Second wastewater connection line
22 Freshwater pump
23 Wastewater pump
24 Bypass line of the supply station
25 Heavy-duty rollers
26 Control device
27 Cruise ship
30 Soap foam dispenser
31 Paper towel dispenser
32 Trash can
33 Sink
34 Handle
35 Heavy-duty hook

1. Mobile handwashing system (1) comprising the following:
a freestanding supply station (2); and
at least one freestanding handwashing station (3),
wherein the supply station (2) comprises a freshwater tank (4), which is fluidly connected or connectable to the at least one handwashing station (3) via a first freshwater supply line (5) and is fluidly connected or connectable to a freshwater supply system via a second freshwater supply line (6); and wherein the supply station (2) comprises a wastewater or graywater tank (7) and/or a wastewater pump (23), which is fluidly connected or connectable to the at least one handwashing station (3) via a first wastewater line (8) and is fluidly connected or connectable to a wastewater disposal or wastewater treatment system via a second wastewater line (9).

2. Handwashing system (1) according to claim 1,
wherein at least two freestanding handwashing stations (3) are provided, wherein the at least two handwashing stations (3) are fluidly connected in series such that a first of the at least two handwashing stations (3) is fluidly connected or connectable directly to the freshwater tank (4) of the supply station (2) via the first freshwater supply line (5) and a second of the at least two handwashing stations (3) is fluidly connected or connectable via a third freshwater supply line (10) to the first of the at least two handwashing stations (3) and from there to the freshwater tank (4) of the supply station (2) via the first freshwater supply line (5).

3. Handwashing system (1) according to claim 2, wherein each handwashing station (3) comprises a first line connection (11) for the first or a third freshwater supply line (5, 10) and a second line connection (12) for a third freshwater supply line (10), wherein a seal, in the form of a backflow blocker, is assigned to each line connection (11, 12) for self-actuated or manual closing of the corresponding line connection (11, 12) when no freshwater supply line (5, 10) is connected to the line connection (11, 12) in question.

4. Handwashing system (1) according to claim 3,
wherein the first line connection (11) is fluidly connected to the second line connection (12) via a first freshwater connection line (13) integrated in the handwashing station (3), and wherein the first freshwater connection line (13) is fluidly connected to a sensor-controlled faucet (15) of the handwashing station (3) via a second freshwater connection line (14) that is integrated in the handwashing station (3).

5. Handwashing system (1) according to claim 3,
wherein at least two freestanding handwashing stations (3) are provided, wherein the at least two handwashing stations (3) are fluidly connected in series such that a first of the at least two handwashing stations (3) is fluidly connected or connectable directly to the wastewater or graywater tank (7) of the supply station (2) via the first wastewater line (8) and a second of the at least two handwashing stations (3) is fluidly connected or connectable via a third wastewater line (17) to the first of the at least two handwashing stations (3) and from there to the wastewater or graywater tank (7) of the supply station (2) via the first wastewater line (8).

6. Handwashing system (1) according to claim 5,
wherein each handwashing station (3) comprises a first line connection (18) for the first or a third wastewater line (8, 17) and a second line connection (19) for a third wastewater line (17), wherein a seal, in the form of a backflow blocker, is assigned to each line connection (18, 19) for self-actuated or manual closing of the corresponding line connection (18, 19) when no wastewater supply line (8, 17) is connected to the line connection (18, 19) in question.

7. Handwashing system (1) according to claim 6,
wherein the first line connection (18) is fluidly connected to the second line connection (19) via a first wastewater connection line that is integrated in the handwashing station (3), and wherein the first wastewater connection line is fluidly connected to a sink (33) of the handwashing station (3) via a second wastewater connection line (20) that is integrated in the handwashing station (3).

8. Handwashing system (1) according to claim 7,
wherein the at least one handwashing station (3) comprises a bypass for the fluid connection of the second line connection (12) for the third freshwater supply line to the second line connection (19) for the third wastewater line (17), as needed.

9. Handwashing system (1) according to claim 1,
wherein the supply station (2) comprises a freshwater pump (22) for establishing and/or maintaining a default or adjustable water pressure in the freshwater tank (4); and/or
wherein the supply station (2) comprises a freshwater pump (22) for establishing and/or maintaining a default or adjustable water pressure in the first freshwater supply line (5); and/or
wherein the supply station (2) comprises a wastewater pump (23) which is fluidly connected or connectable on the suction side to the first wastewater line (8) and is fluidly connected or connectable on the pressure side to the second wastewater line (9); and/or
wherein the supply station (2) comprises a wastewater pump (23) which is fluidly connected or connectable on the suction side to the wastewater or graywater tank (7) and is fluidly connected or connectable on the pressure side to the second wastewater line (9).

10. Handwashing system (1) according to claim 1,
wherein the freshwater tank (4) of the supply station (2) is arranged at least in regions above the wastewater or graywater tank (7) of the supply station (2), and wherein further a bypass line (24) with a valve, which can be operated manually or controlled via a control device (26), is provided in order to form a fluid connection between the freshwater tank (4) and the wastewater or graywater tank (7) of the supply station (2), as needed.

11. Handwashing system (1) according to claim 1,
wherein the freshwater supply system is separate from the public freshwater network, and wherein the freshwater supply system is an on-board drinking water supply system of a ship (27); and/or
wherein the wastewater disposal or wastewater treatment system is separate from the public wastewater network, and wherein the wastewater disposal or wastewater treatment system is an on-board wastewater disposal or wastewater treatment system of a ship (27).

12. Handwashing system (1) according to claim 1,
wherein the supply station (2) and the at least one handwashing station (3) are respectively configured as a mobile unit and equipped with heavy-duty rollers or heavy-duty wheels (25); and/or
wherein the at least one handwashing station (3) comprises a power supply that is autonomous from the supply station (2) in order to supply power to the electrical consumers of the handwashing station (3), wherein the self-contained power supply comprises an accumulator and a water-flow generator and/or a photovoltaic cell.

13. Handwashing system (1) according to claim 1,
wherein a level sensor is assigned to the freshwater tank (4) of the supply station (2), said level sensor being signally connected to a control device (26) of the supply station (2), wherein the control device (26) is configured in order to establish a fluid connection of the freshwater tank (4) to the freshwater supply system via the second freshwater supply line (6) upon reaching or falling below a default or adjustable liquid level in the freshwater tank (4) sensed by means of the level sensor; and/or
wherein a level sensor is assigned to the wastewater or graywater tank (7) of the supply station (2), said level sensor being signally connected to a control device (26) of the supply station (2), wherein the control device (26) is configured in order to establish a fluid connection of the wastewater or graywater tank (7) to the wastewater disposal or wastewater treatment system via the second wastewater line (9) upon reaching or exceeding a default or adjustable liquid level in the wastewater or graywater tank (7) sensed by means of the level sensor.

14. Handwashing system (1) according to claim 1,
wherein a temperature sensor is assigned to the wastewater or graywater tank (7) of the supply station (2) and/or the freshwater tank (4) of the supply station (2) for monitoring the temperature of the wastewater supplied by the at least one handwashing station (3) to the wastewater or graywater tank (7) or for monitoring the temperature of the freshwater supplied by the freshwater tank (4) of the at least one handwashing station (3), wherein the at least one temperature sensor is signally connected to a control device (26) of the supply station (2), and wherein the control device (26) is configured in order to interrupt or prevent a supply of freshwater to the at least one handwashing station (3) when the temperature of the freshwater in the freshwater tank (4) and/or the temperature of the wastewater in the wastewater or graywater tank (7) sensed by the temperature sensor reaches or exceeds a default or adjustable value of approximately 40° C.

15. Handwashing system (1) according to claim 1,
wherein a tempering device is assigned to the freshwater tank (4) of the supply station (2) in order to temper the liquid received in the freshwater tank (4).
